(19) United States
(12) Patent Application Publication
(10) Pub. No.: US 2009/0269729 A1
(43) Pub. Date: Oct. 29, 2009

(54) SYSTEM FOR TRACKING THE PASSAGE OF TIME

(76) Inventor: Carol M. McCoy, Grafton, WI (US)

Correspondence Address: BOYLE FREDRICKSON S.C., 840 North Plankinton Avenue, MILWAUKEE, WI, 53203, US

(21) Appl. No.: 12/110,648

(22) Filed: Apr. 28, 2008

(51) Int. Cl. G09B 19/12; G04B 19/00

(52) U.S. Cl. 434/304; 368/45

(57) ABSTRACT

Systems and methods for tracking the passage of time are described. One system includes a predetermined event and a set of counting units, with each counting unit having a first side displaying a number. Each number corresponds to a number of time increments until the predetermined event. Each counting unit has a second side displaying a portion of an image corresponding with the predetermined event, and when the counting units are arranged in a predetermined arrangement the image is produced.

### BACKGROUND OF THE INVENTION

1. Field of the Invention

The present invention relates in general to tracking the passage of time. More particularly, the present invention relates to a system and method for tracking the amount of time until the occurrence or arrival of a predetermined event.

2. Discussion of the Related Art

It is well known that the abstract concept of time may be difficult for a child to comprehend. Thus, it is difficult to explain to a child and for a child to understand how much time there is before the occurrence of an event, e.g., how many days there are until the child's birthday.

Historically, certain systems have been used to count the days until an event. For example, Advent calendars are used to count the days until Christmas. However, Advent calendars are typically designed for only one use and are then discarded. Moreover, they are only designed for use with one particular event, i.e., Christmas.

What is needed therefore is a system for tracking the passage of time that helps the user, e.g., a child or individual with special needs, to understand how much time there is before a predetermined event. Further, what is also needed is a system that incorporates objects familiar to a child, e.g., toy blocks, to physically demonstrate to the child how much time remains before a predetermined event. Still further, what is needed is a system that may be repeatedly used to count the time remaining until multiple predetermined events.

### SUMMARY AND OBJECTS OF THE INVENTION

By way of summary, the present invention is directed to a system for tracking the passage of time, and more specifically to a system that a child can use to track the amount of time until a predetermined event, e.g., the child's birthday. An effect of the present invention is to help a child conceptualize the abstract concept of time by using numbered counting units. Another object of the invention is to provide a system that is suitable for use by a child, e.g., one that is durable and lightweight. Another object of the invention is to provide an apparatus that has one or more of the characteristics discussed above but which is relatively simple to manufacture and assemble using a minimum of equipment.

In accordance with a first aspect of the invention, these objects are achieved by providing a system for tracking the passage of time including a predetermined event and a set of blocks. Each block has a number corresponding to a number of time increments remaining until the predetermined event. The system further includes an image related to the predetermined event, with each block displaying a portion of the image. The image is produced when the blocks are arranged in a predetermined arrangement.

In accordance with another aspect of the invention, a method for tracking the passage of time includes the step of providing a set of counting units with each counting unit displaying a number corresponding to a position of the counting unit within the set of counting units and a portion of an image. In another step, the counting units are arranged in a predetermined arrangement displaying the numbers. In another step, the counting unit with a highest number is removed after a predetermined time marker has passed. In still another step, the removed counting unit is placed in a predetermined position displaying the portion of the image on the counting unit. These steps are repeated until all of the counting units have been removed and the image is displayed.

In accordance with still another aspect of the present invention, a system for tracking the passage of time includes a predetermined event and a set of counting units. Each counting unit has a first side displaying a number corresponding to a number of time increments until the predetermined event. Each counting unit also has a second side displaying a portion of an image corresponding with the predetermined event, and arranging the counting units in a predetermined arrangement produces the image.

These and other aspects and objects of the present invention will be better appreciated and understood when considered in conjunction with the following description and the accompanying drawings. It should be understood, however, that the following description, while indicating preferred embodiments of the present invention, is given by way of illustration and not of limitation. Many changes and modifications may be made within the scope of the present invention without departing from the spirit thereof, and the invention includes all such modifications.

### BRIEF DESCRIPTION OF THE DRAWINGS

A clear conception of the advantages and features constituting the present invention, will become more readily apparent by referring to the exemplary, and therefore non-limiting, embodiments illustrated in the drawings accompanying and forming a part of this specification, wherein like reference numerals designate the same elements in the several views, and in which:

FIG. 1 is a plane view of a system of the present invention wherein the counting units are in a pyramid arrangement;

FIG. 2 is a plane view of the system of FIG. 1 wherein the counting units are positioned to display an image;

FIG. 3 is rear view of the arrangement shown in FIG. 2;

FIG. 4 is the system of FIG. 1 wherein five of the counting units have been removed from the pyramid arrangement and positioned to display a portion of an image;

FIG. 5 is a perspective view of one of the counting units, e.g., a block, of the system of FIG. 1; and

FIG. 6 is a method of tracking time according to the present invention.

In describing the preferred embodiment of the invention which is illustrated in the drawings, specific terminology will be resorted to for the sake of clarity. However, it is not intended that the invention be limited to the specific terms so selected and it is to be understood that each specific term includes all technical equivalents which operate in a similar manner to accomplish a similar purpose. For example, the word “connected”, “attached”, or terms similar thereto are often used. They are not limited to direct connection or attachment but include connection through other elements where such connection is recognized as being equivalent by those skilled in the art.

### DESCRIPTION OF PREFERRED EMBODIMENTS

The present invention and the various features and advantageous details thereof are explained more fully with reference to the non-limiting embodiments described in detail in the following description.

### 1. System Overview

As discussed above, the present invention includes a system and method for tracking the passage of time until a predetermined event. More specifically, the system and method are preferably for use by child, e.g., to count the number of days until the child's birthday. However, the system could be used by a person of any age (e.g., an elderly person with Alzheimer's) and in association with any desired predetermined event, e.g., a birthday, a holiday, or any special event. Additionally, the system may be used repeatedly and for multiple predetermined events, e.g., the system may incorporate many different images that are associated with a variety of predetermined events.

### 2. Detailed Description of Preferred Embodiments

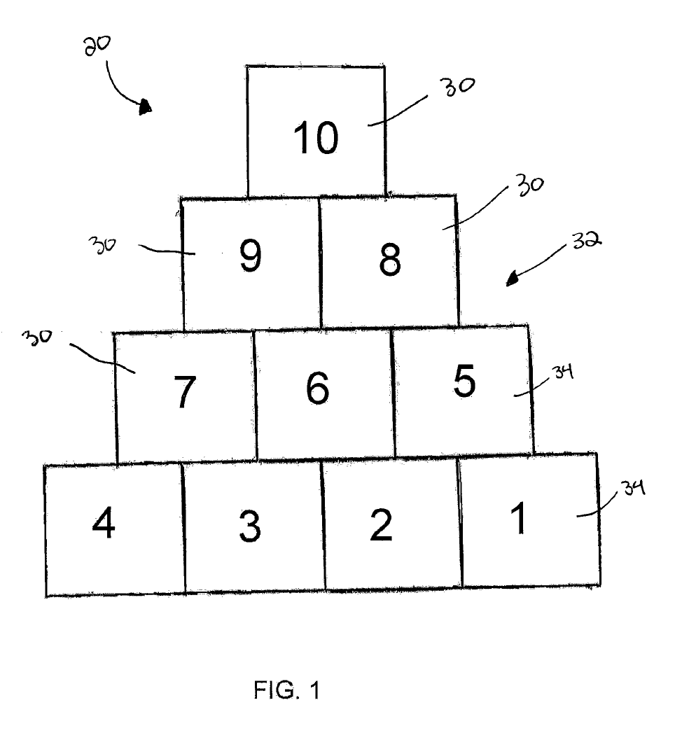

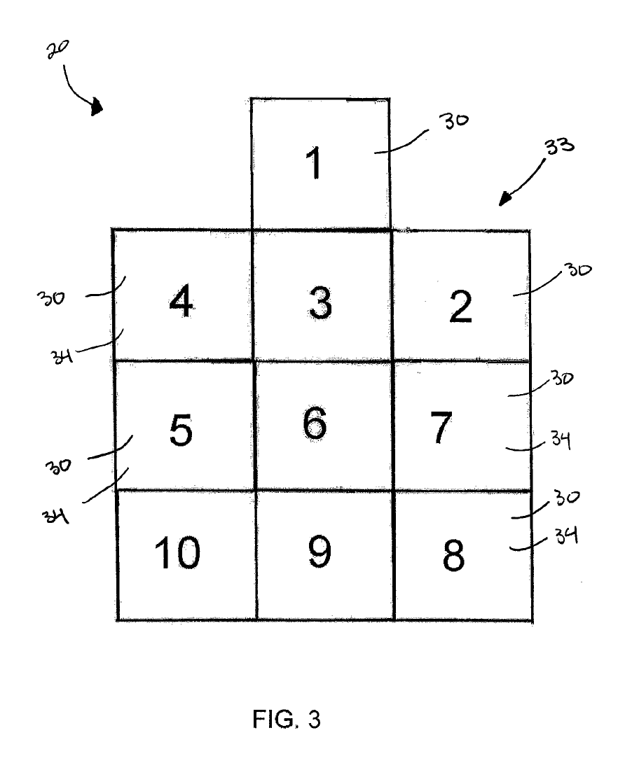

One embodiment of a system 20 for tracking the passage of time in accordance with the present invention is shown in FIGS. 1-4. Generally speaking, the system 20 comprises a set of counting units 30. Each counting unit 30 has number corresponding to the position of the counting unit 30 in the set, e.g., in a system 20 having ten counting units 30, the counting units 30 would be labeled one through ten. The system 20 of counting units 30 is used to count the number of time increments leading up to a predetermined event, e.g., it is used as a countdown of the number of days before a birthday. Each one of the counting units 30 also has a portion 40 of an image 42 that corresponds with the predetermined event, e.g., a birthday cake when the predetermined event is a birthday. Thus, when the counting units 30 are arranged in a predetermined arrangement, the image 42 is displayed.

The system 20 of the present invention is used as follows. The counting units 30 are arranged in a first predetermined arrangement 32, preferably clearly displaying the numbers on the counting units 30. After the passage of a predetermined time increment, e.g., a minute, hour, day, month, the counting unit 30 having the highest number is removed from the first predetermined arrangement 32 and positioned in a second predetermined arrangement 33 so that a portion 40 of an image 42 corresponding with a predetermined event is displayed. These steps are repeated, i.e., a counting unit 30 is removed after each passage of a predetermined time increment, until all counting units 30 have been removed from the first predetermined arrangement 32 and placed in the second predetermined arrangement 33, signifying the arrival of the predetermined event.

As shown in FIGS. 1-4, in the preferred embodiment of the present invention the counting units 30 are blocks. The construction of children's blocks is well-known to those skilled in the art and therefore a detailed description thereof is not necessary to fully understand the present invention which is directed to novel improvements in a system for tracking the passage of time.

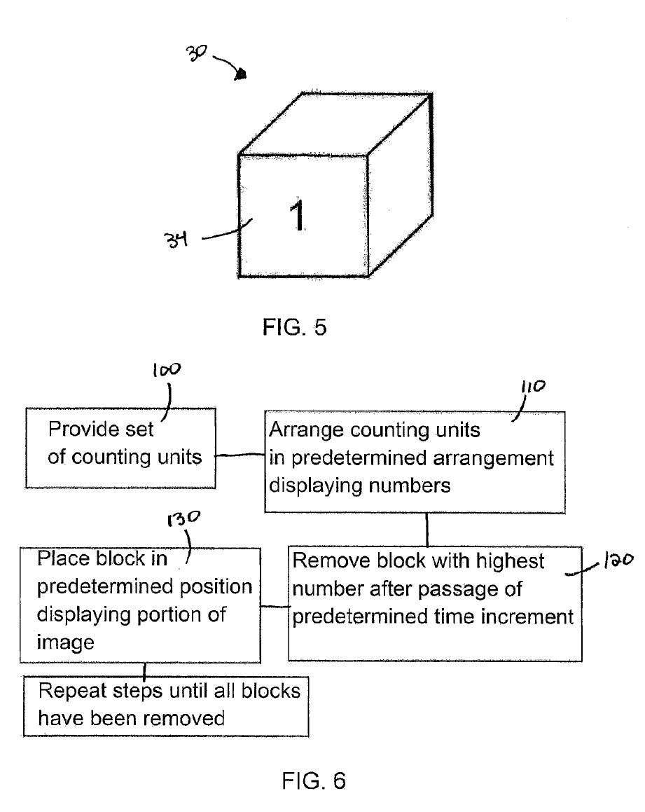

The size and shape of the blocks may vary, but preferably the blocks are substantially cubical, each block having a height, length and width of between about one inch and about two inches, and more preferably of about 1½ inches. See, e.g., FIG. 5. The blocks may be made from any suitable material for use by children, e.g., a material that is light-weight, durable and non-toxic, such as plastic or wood. Preferably the blocks are made from wood.

The preferred embodiment shown in FIGS. 1-4 has ten counting units 30. However, the number of counting units 30 can vary as desired.

In the embodiment of FIGS. 1-4, each block has a first side 34 having a number. As discussed above, in the preferred embodiment the blocks are numbered one through ten as shown in FIG. 1 for example. The size, style and color of the numbers may vary as desired. Preferably, the numbers are all of generally the same style and size to create a substantially uniform set.

The blocks may be arranged in any first predetermined arrangement 32 to display the numbers. In one arrangement, as shown in FIG. 1, the blocks are arranged in a pyramid with the blocks having numbers one (1) through four (4) forming the bottom row, the blocks having numbers five (5) through seven (7) forming the second row, the blocks having numbers eight (8) and nine (9) forming the third row, and the block having number ten (10) forming the fourth row. The pyramid may be horizontal, e.g., laid flat on the ground or other surface, or it may be vertically, e.g., the blocks may be stacked on top of one another. This first predetermined arrangement 32 allows for the blocks to be removed from the pyramid from the top down and in an orderly fashion. However, any desired first predetermined arrangement 32 may be used.

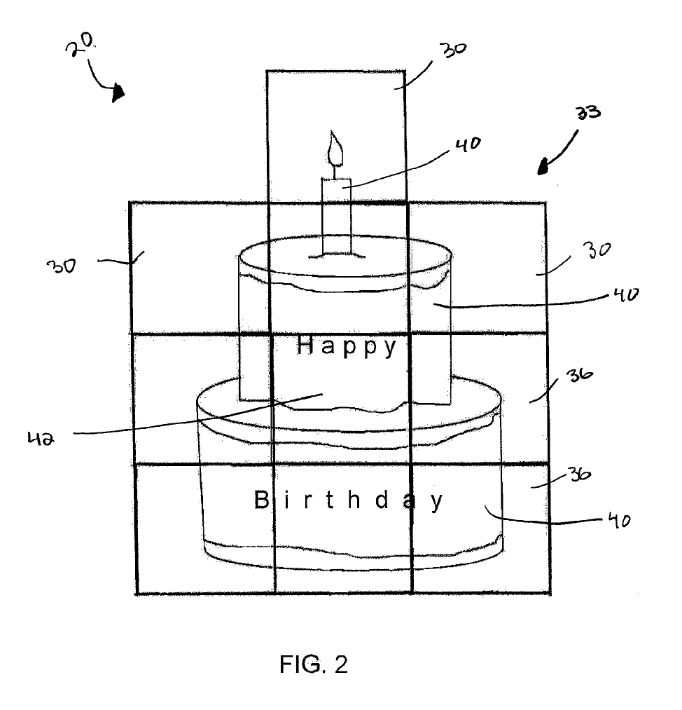

Each block has a second side 36 having a portion 40 of an image 42 corresponding with a predetermined event. For example, the image 42 may be a birthday cake when the predetermined event is a birthday, see, e.g., FIG. 2, or a Christmas tree when the predetermined event is Christmas. The system 20 of the present invention may be used in conjunction with any desired predetermined event and corresponding image 42. Some further examples of images 42 are a flower, balloons and a fireworks display.

As discussed above, the image 42 is produced or displayed by removing the blocks one at a time from the first predetermined arrangement 32 and then positioning them in a second predetermined arrangement 33 so that the portion 40 of the image 42 on a respective block is displayed. Given that the blocks are removed in an orderly fashion, e.g., by removing blocks from the first predetermined arrangement 32 in descending order, the image 42 is preferably produced by positioning the blocks in a similarly logical order in the second predetermined arrangement 33.

For example, in one embodiment the second predetermined arrangement 33 is as follows: the blocks numbered ten (10) through eight (8) form the first row of the image 42, the blocks numbered seven (7) through five (5) form the second row of the image 42, the blocks numbered four (4) through two (2) form the third row of the image 42, and the block having number one (1) forms the fourth row of the image 42. Thus, the image 42 is preferably assembled in a logical order, e.g., the blocks are removed from the first predetermined arrangement 32 in descending numerical order and the image 42 is displayed by placing block number nine (9) next to block number ten (10) and then block number eight (8) next to block number nine (9) and so on. Other similar arrangements may be used to produce or display the image 42.

As discussed above, removing the final block, e.g., block number one (1), from the first predetermined arrangement 32 signifies the arrival of the predetermined event. In another aspect of the invention, the final block may have a portion 40 of an image 42 that has a special significance. For example, where the predetermined event is a birthday, the portion 40 of the image 42 on the final block may be the flame on a candle, i.e., the candle is lit to complete the image of the birthday cake and signify the arrival of a birthday. See, e.g., FIG. 2. In another example, the predetermined event is Christmas and the portion 40 of the image 42 on the final block is a star, i.e., the star is placed atop the Christmas tree on Christmas morning to signify the arrival of Christmas.

In another aspect of the invention, the blocks may be customized by the user. For example, certain photographs associated with certain events, e.g., a family photo from a Fourth of July celebration, may be used as images. The placement and/or printing of photographs and other images on various items is well-known to those skilled in the art and therefore a detailed description thereof is not necessary to fully understand the present invention.

The remaining sides of the blocks may also have images 42 corresponding to other predetermined events. Thus, in the embodiment of FIGS. 1-4, where the blocks are cubical in shape, i.e., each block has six sides, the system 20 may feature up to five different images 42.

The present invention further contemplates a method for tracking the passage of time. Though the method could be employed by any user, its preferred use is to assist young children in understanding how much time there is until the occurrence of a predetermined event, e.g., how many days there are until the child's birthday.

The method includes the following steps. See, e.g., FIG. 6. Step 100 is providing a set of counting units, e.g., blocks, wherein each block has a number corresponding to a position of the block within the set of blocks and a portion of an image. Step 110 is arranging the blocks in a predetermined arrangement displaying the numbers. Step 120 is removing the block with a highest number after a predetermined time marker has passed. Step 130 is placing the removed block in a predetermined position displaying the portion of the image on the block. Steps 120 and 130 are then repeated until all of the blocks have been removed from the predetermined arrangement and are positioned so as to display the image, signifying the arrival of the predetermined event.

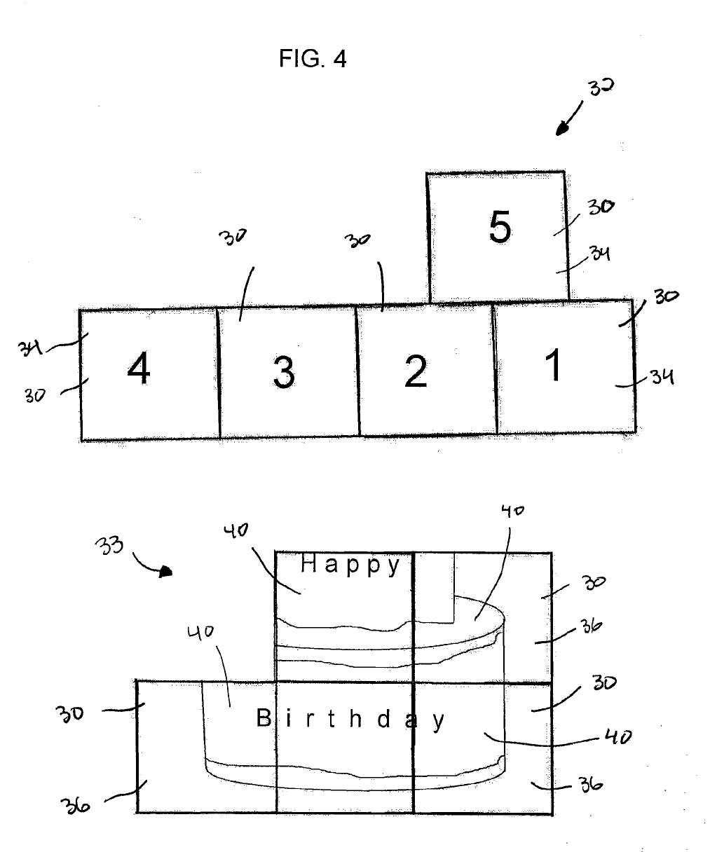

As discussed above, the predetermined time marker could be any time increment, e.g., minute, hour, day, week, or month. Preferably, the time marker is a day, and still more preferably, the time marker is the beginning of the day. For example, at the start of a new day, a child would remove the highest block from the predetermined arrangement. The number of blocks remaining indicates the number of days until the predetermined event, e.g., if the child removes block six from the arrangement leaving five blocks then there are five days until the predetermined event. See, e.g., FIG. 4. In the same example, on the morning of the final day, the child removes the final block, e.g., the block having number one (1), and completes the image, signifying that the day of the predetermined event has arrived, e.g., it is the child's birthday.

In another embodiment of the invention (not shown), the counting units 30 are in the form of substantially two-dimensional puzzle pieces. Thus, one side 34 of the puzzle piece has a number and the other side 36 has an image 42. In another aspect of the invention, the system further includes a frame for holding the puzzle pieces. The frame may have indicators showing where each respective puzzle piece should be positioned. For example, a surface of the frame may have an outline corresponding to the shape of a certain puzzle piece, e.g., piece number six, and it may also have the number six within the outline of the piece. Thus, the frame serves as a guide or pattern for assembling the pieces to form the image. The method described above for counting time increments until the arrival of a predetermined event can be used in conjunction with the puzzle-piece embodiment.

The system 20 may further include instructions detailing how the system 20 is to be used, e.g., by using the method described above. For example, the instructions may include the steps of arranging the counting units 30, e.g., blocks, in a first predetermined arrangement 32 displaying the numbers, removing the block with a highest number after a time increment has passed, placing the removed block in a predetermined position displaying the portion of the image on the block, and repeating these steps until all of the blocks have been removed and the complete image is displayed. The instructions may be provided in any tangible form, e.g., on a piece of paper or on packaging for the system. The instructions may be written, in pictorial form, or in a combination of words, pictures, symbols, and graphics

The instructions may further include a complete picture of the image 42 (or images) that are formed by the counting units 30. Thus, the instructional picture can be used as a guide when the child is positioning the counting units 30 to display a portion 40 of and eventually the entire image 42.

All the disclosed embodiments are useful in conjunction with tracking the passage of time such as are used for the purpose of helping a child or other person to understand how many days there are before a certain event, e.g., the child's birthday. There are virtually innumerable uses for the present invention, all of which need not be detailed here. All the disclosed embodiments can be practiced without undue experimentation.

Although the best mode contemplated by the inventor of carrying out the present invention is disclosed above, practice of the present invention is not limited thereto. It will be manifest that various additions, modifications and rearrangements of the features of the present invention may be made without deviating from the spirit and scope of the underlying inventive concept.

In addition, the individual components need not be fabricated from the disclosed materials, but could be fabricated from virtually any suitable materials.

Moreover, the individual components need not be formed in the disclosed shapes, or assembled in the disclosed configuration, but could be provided in virtually any shape, and assembled in virtually any configuration that displays the image 42 when positioned accordingly. Furthermore, all the disclosed features of each disclosed embodiment can be combined with, or substituted for, the disclosed features of every other disclosed embodiment except where such features are mutually exclusive.

It is intended that the appended claims cover all such additions, modifications and rearrangements. Expedient embodiments of the present invention are differentiated by the appended claims.

I claim:

1. A system for tracking the passage of time comprising:
a predetermined event;
a set of blocks, each block having a number corresponding to a number of time increments remaining until the predetermined event; and
an image related to the predetermined event;
wherein each block displays a portion of the image; and
wherein arranging the blocks in a predetermined arrangement produces the image.

2. The system of claim 1, further comprising instructions for:
(a) arranging the blocks in a predetermined arrangement displaying the numbers;
(b) removing the block with a highest number after a time increment has passed;
(c) placing the removed block in a predetermined position displaying the portion of the image on the block; and
(d) repeating steps (b)-(c) until all of the blocks have been removed and the complete image is displayed.

3. The system of claim 2, wherein the image is a first image, and wherein each block contains a portion of a second image.

4. The system of claim 3, wherein each block contains a portion of a third image, a portion of a fourth image, and a portion of a fifth image.

5. The system of claim 3, wherein the set comprises ten blocks.

6. The system of claim 5, wherein the first image corresponds to the blocks as follows:
the blocks having numbers 10, 9 and 8 form a first row of the first image;
the blocks having numbers 7, 6 and 5 form a second row of the first image;
the blocks having numbers 4, 3 and 2 form a third row of the first image; and
the block having number 1 forms a fourth row of the first image.

7. The system of claim 6, wherein the first image is at least one of: a birthday cake, a Christmas tree, a flower, balloons and a fireworks display.

8. The system of claim 7, wherein first image is a custom image.

9. A method for tracking the passage of time comprising the steps of:
(a) providing a set of counting units, each counting unit displaying a number corresponding to a position of the counting unit within the set of counting units and a portion of an image;
(b) arranging the counting units in a predetermined arrangement displaying the numbers;
(c) removing the counting unit with a highest number after a predetermined time marker has passed;
(d) placing the removed counting unit in a predetermined position displaying the portion of the image on the counting unit;
(e) repeating steps (c)-(d) until all of the counting units have been removed and the image is displayed.

10. The method of claim 9, wherein the counting units are blocks.

11. The method of claim 9, wherein the predetermined time marker is the start of a new day.

12. The method of claim 11, wherein removal of the final counting unit corresponds with a predetermined event.

13. The method of claim 12, wherein the predetermined event is a birthday and where the image is a birthday cake.

14. The method of claim 10, wherein the set comprises ten blocks.

15. The method of claim 14, wherein the predetermined arrangement of step (b) is a vertical pyramid wherein the blocks having numbers 1, 2, 3 and 4 form the bottom row, the blocks having numbers 5, 6 and 7 form the second row, the blocks having numbers 8 and 9 form the third row, and the block having number 10 forms the fourth row.

16. A system for tracking the passage of time comprising:
a predetermined event; and
a set of counting units, each counting unit having a first side displaying a number corresponding to a number of time increments until the predetermined event and a second side displaying a portion of an image corresponding with the predetermined event;
wherein arranging the counting units in a predetermined arrangement produces the image.

17. The system of claim 16, wherein the set of counting units comprises ten blocks.

18. The system of claim 17, wherein each block displays a portion of a second image.

19. The system of claim 16, wherein the set of counting units comprise ten substantially two-dimensional puzzle pieces.

20. The system of claim 19, further comprising a frame to house the puzzle pieces when the puzzle pieces are positioned in a predetermined arrangement.
